(19) United States
(12) Patent Application Publication
(10) Pub. No.: US 2024/0202853 A1
(43) Pub. Date: Jun. 20, 2024

(54) SYSTEM AND METHOD FOR GENERATING A DYNAMIC INDIVIDUALIZED VEHICULAR PROFILE BASED ON UNIQUE VEHICULAR IDENTIFIERS

(71) Applicant: MOTOROLA SOLUTIONS, INC., Chicago, IL (US)

(72) Inventors: BARBARA R. DOUTRE, PLANTATION, FL (US); LIN LIN, INVERNESS, IL (US); CAROLINE J. WATSON, HUNTLEY, IL (US); RUPA S. VASARA, NAPERVILLE, IL (US); JOHN K. KLINGERT, WARREN, NJ (US)

(21) Appl. No.: 18/068,829

(22) Filed: Dec. 20, 2022

(51) Int. Cl. G06Q 50/26; G06V 10/44; G06V 10/74; G06V 20/54; G06V 20/58; H04N 7/18

(52) U.S. Cl. CPC G06Q 50/265; G06V 10/44; G06V 10/761; G06V 20/54; G06V 20/58; H04N 7/181

(57) ABSTRACT

A system and method for generating a vehicular profile and vehicular profiling system are provided. A request for enrollment in the system is received at a processing device. Live captured images of the vehicle to-be-enrolled and previously recorded images of a base version of the vehicle are processed and compared to detect differences therebetween. The differences are characterized to identify unique identifiers of the vehicle. The vehicular profile is generated including the characterized unique identifiers along with a recoverability-likelihood score. The profile, including the recoverability-likelihood score, is communicated to a primary device associated with capturing the live captured images. The profile including the recoverability-likelihood score may be further communicated to a secondary device having access permissions to the system.

### FIELD OF THE INVENTION

The present invention relates generally to communication systems and more particularly to the generation of vehicular profiles.

### BACKGROUND

Motor vehicle theft is the criminal act of stealing or attempting to steal a motor vehicle. According to the National Insurance Crime Bureau (NICB) nearly half a million vehicles were stolen in the United States in the first half of 2022, equating to an estimated $4.5 billion dollars' worth of vehicle losses from thefts. This represents a 25% increase over the vehicle theft total reported for the first half of the year in 2019. Car prices (both new and used) have increased making the crime of auto theft increasingly lucrative for criminals.

Many vehicles are stolen for parts and/or drug running, making the ability to recover the vehicle quickly very important. Vehicle insurance may protect the owner against vehicle theft, but the increase in auto theft further drives up the cost of such insurance. There is an increasing desire for insurance companies, consumers and law enforcement agencies to partner together in a proactive manner to prevent, deter, and/or facilitate recovery of vehicle theft.

Accordingly, there is a need for products, features, and/or services aimed at targeting the growing problem of vehicle theft and recovery.

### BRIEF DESCRIPTION OF THE FIGURES

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a communication system block diagram for dynamic vehicular profiling formed and operating in accordance with some embodiments.

FIG. 2 is an illustration of example display output of vehicular identifiers and associated scores generated by the vehicular profiling system of FIG. 1 in accordance with some embodiments.

FIG. 3 is an example timeline for vehicular profiling in accordance with some embodiments.

FIG. 4 is a flowchart of a method for generating a vehicular profile in accordance with some embodiments.

FIG. 5 is a flowchart of a method for updating a vehicular profile in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Briefly, there is provided a system and method for generating a vehicular profile and vehicular profiling system are provided. A request for enrollment in the system is received at a computing device. The computing device processes live captured images of the vehicle to-be-enrolled and previously recorded images of a base version of the vehicle. The images are compared to detect differences between, and to characterize the differences to identify unique identifiers of the vehicle. The vehicular profile is generated including the characterized unique identifiers along with a recoverability-likelihood score. The profile including the characterized unique identifiers may be communicated to a primary device associated with capturing the live captured images. The profile including the characterized unique identifiers and recoverability-likelihood score may be communicated to a secondary device having access permissions to the system.

The embodiments associated with the vehicular profiling system advantageously facilitate the expedited recovery of stolen vehicles which is a benefit to both law enforcement agencies and insurance agencies, The embodiments further provide for improved monitoring of vehicle conditions, which can impact insurance claims and associated costs.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

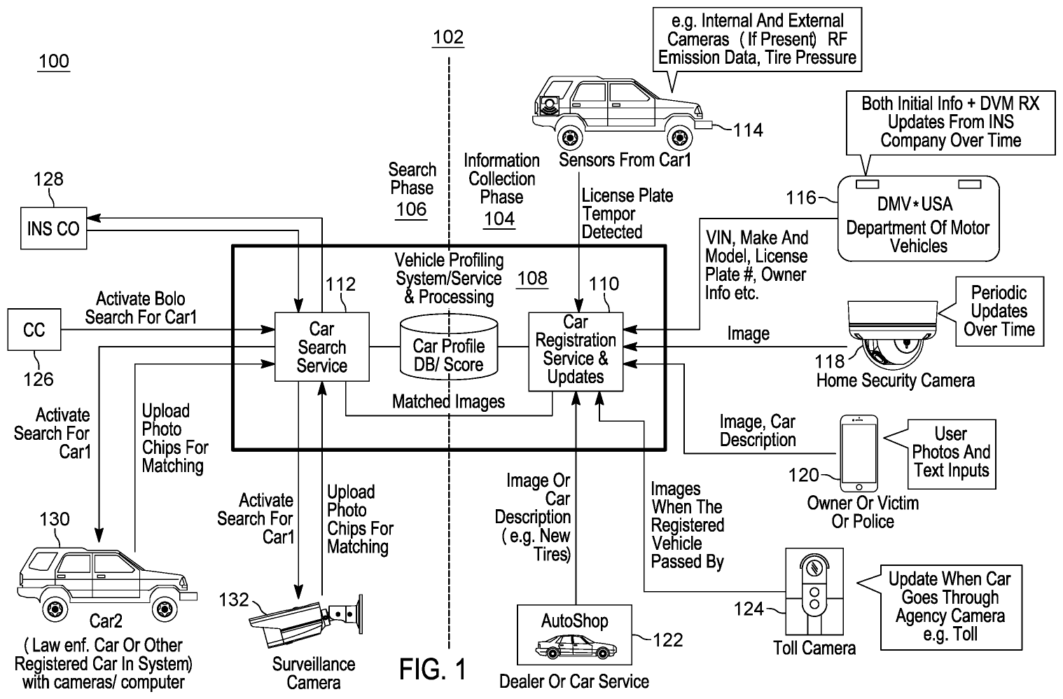

FIG. 1 is a block diagram of a communication system 100 formed and operating in accordance with some embodiments. Communication system 100 includes a vehicular profiling system 102 which interoperates with various vehicular information sources and image capturing devices to build a vehicular profile based on unique vehicular identifiers, generate a recoverability score based on those unique identifiers, and to communicate that vehicular profile including the unique identifiers and recoverability-likelihood score upon request.

The vehicular profiling system 102 may interoperate with the various vehicular information sources and image capturing devices using one or more communications networks. The various sources and devices include respective microprocessors and transceivers which may operate using broadband and/or or narrowband communications, as appropriate, to communicate with the vehicular profiling system 102.

The vehicular profiling system 102 provides an information collection phase 104 and a search phase 106 collectively managed by processing database 108. The processing database 108 includes one or more processors for processing images and information pertaining to a vehicle and at least one memory for image and data storage. The one or more processors may include, for example, an interactive vehicular video processor configured to process and perform analytics on live captured images of a vehicle to-be-enrolled in the system and previously recorded images of a base version of the vehicle.

The processing database 108 may execute one or more machine learning algorithm(s) to generate and store the vehicular profile, including identification of unique and temporary identifiers along with associated recoverability-likelihood scores, as well as an overall recoverability-likelihood score for the vehicle. The machine learning algorithms may apply different thresholds to different identifiers to determine the recoverability-likelihood scores. The processing database 108 further dynamically updates the vehicular profile as identifiers are added or removed, thereby providing for customized profiling of each vehicle enrolled in the system. Received queries to the system, requesting the vehicle profile, are thus able to obtain a more accurate profile. The system and algorithms further provide post-theft updates to the vehicular profile based on identifiers predicted to change over time.

The vehicle may be enrolled and images uploaded via a car registration service 110 of vehicular profiling system 102 and communicated to the processing database 108. For example, for a vehicle 114 to be enrolled in the system, base vehicle information (VIN, make, model, license plate number, owner information) and images associated with that make and model may be retrieved from, for example, a department of motor vehicles (DVM) database 116, which may further include, for example, insurance records associated with the vehicle. The live captured images with the vehicle may be uploaded from a variety of video sources operatively coupled to the vehicular profiling system 102. The video sources may include, but are not limited to, internal and external cameras located on the vehicle 114, images from security cameras 118 (such as home, office or otherwise associated with vehicle 114), images from user cell phone 120, images from a car dealership or car service shop 122, and toll cameras 124. The images may further include tagged information, such as date, time, and/or location. The video sources which are associated with an agency, such a toll cameras registered to the system, may automatically upload live captures imaged when registered vehicle 114 passes the agency camera. The video sources associated with an enrolled vehicle and operatively coupled to the vehicular profiling system 102 may send updated live captured images of the vehicle 114 over time. For example, cameras associated with automotive dealerships or service shops may upload updated live captured images of vehicle 114 when the vehicle is being serviced.

The processor of vehicular profiling system 102 then compares the live captured images to the previously recorded images of the base version of the vehicle to detect differences between them, characterize the differences to identify unique identifiers; generate a vehicular profile including the characterized unique identifiers, generate a recoverability-likelihood score based on the characterized unique identifiers, and provide the recoverability-likelihood score to a primary device associated with capturing of the live captured images. It is to be appreciated that the live captured images may, but need not, originate from the primary device itself. Upon receipt of a query, the vehicular profile including the unique identifiers may be uploaded to one or more secondary devices. Access permissions to the secondary devices may have been previously established during enrollment and/or may be granted in response to an incident report trigger received by the system. For example, secondary devices associated with law enforcement may be provided access in response to a query associated with a stolen vehicle notification or report. As another example, secondary devices associated with insurance or leasing companies may be provided access in response to a query associated with a stolen vehicle report, an environmental incident, or other trigger having potential impact on the enrolled vehicle. Insurance companies, leasing companies and/or other agencies having a vested interest in the vehicle may also receive automated vehicular profile reports on an automated basis, in accordance with access permissions configured during enrollment.

Additionally, the vehicle profile information may further include text and/or audio inputs pertaining to a vehicle's appearance (identifiers) sent from a computer or cell phone linked to the vehicular profiling system 102. These text inputs and/or audio inputs may be cross-correlated with the photographic inputs to generate the updated individualized vehicular profile. For example, green paint on back passenger side tire may trigger a focused photo of that tire to include in the profile.

In some embodiments, the vehicular profiling system 102 may operate as part of a subscription service. For example, an insurance company may pay for auto dealerships or maintenance facilities, to automatically update a vehicular profile for vehicles that come in for regular maintenance (such as oil changes) and vehicular service on a regular basis, via ins company, law enforcement app, car dealer app, AAA, etc). The query may be received, from one or more subscribers to the vehicular profiling system 102. Such subscribers may include but are not limited to law enforcement agencies, shown as command central (CC) 126, insurance company 128, and/or consumer or agent subscriber 124.

The remote cameras of the vehicular profiling system 102 may include, but are not limited to, law enforcement vehicle(s) 130, or other registered vehicle in the system, having in-vehicle and/or on-vehicle camera(s), remote surveillance camera(s) 132 associated with surveillance agencies, and/or toll camera(s) 124 associated with transportation agencies that may be affiliated with the vehicle profile system. For example, a query may be transmitted to vehicular profiling system 102 upon report of stolen vehicle at command central (CC) 126 and/or insurance company 128. The vehicle profile including the unique identifiers and recoverability score may be uploaded to a law enforcement agency device of law enforcement vehicle(s) 130 and/or a system or agency associated with remote surveillance camera(s) 132. Photos with identifiers and associated scoring may be sent to the vehicle's in-vehicle computer for display, which will facilitate an officer's ability to identify a stolen vehicle. A potential match may also be detected by an in-vehicle computer of vehicle 130 based on images captured by the the on-vehicle cameras. Additionally, photos captured by cameras of vehicle 130 and/or surveillance cameras 132 of a potentially stolen vehicle may be uploaded to the car search service 112 for match verification via processing database 108. The ability to identify stolen vehicles that have been altered has been greatly facilitated by the vehicular profiling system 102 providing identifiers and scores. The ability to identify even small unique characteristics greatly improves the ability to identify an altered vehicle based on a unique identifier score being high and minimizing the lack of presence of other identifiers (based on an identifier score being low).

The vehicular profiling system 102 may be further refined, for example the recoverability-likelihood score may be updated, as additional unique identifiers are detected via additionally provided live captured images from one or more of the image capturing sources. The vehicular profiling system 102 may be further refined, for example by generating a visual representation for display on a secondary device, the visual representation including: identifiers associated with the vehicle and an associated impact of each identifier on the recoverability-likelihood score. The recoverability-likelihood score may also be adjusted (or updated) based on unique identifiers that can be modified over time. The interactive vehicular video processor may further be configured to: further characterize the unique identifiers to separately identify temporary and permanent unique identifiers of the vehicle to-be-enrolled; generate the recoverability-likelihood score based on relatively lower weights applied to the temporary unique identifiers and relatively higher weights applied to the permanent unique identifiers. In some embodiments, the individual scoring/weighting may be dynamically updated based on machine learned and/or stored information pertaining to a vehicle's make/model statistics (insurance agency statistics), such as statistics pertaining to a make/model being known for being dismantled quickly and/or modified for resale in stolen vehicle markets. The weighted identifiers and updated recoverability-likelihood scores may be provided to the primary device, the primary device may be associated with a user/consumer and/or an insurance company. In other words, a vehicle need not be stolen to take advantage of the vehicular profiling system 102. Insurance companies, leasing companies may subscribe to such a profiling service to determine how well a vehicle is being maintained. Discounts may be provided to user/consumers willing to subscribe to such a profiling service.

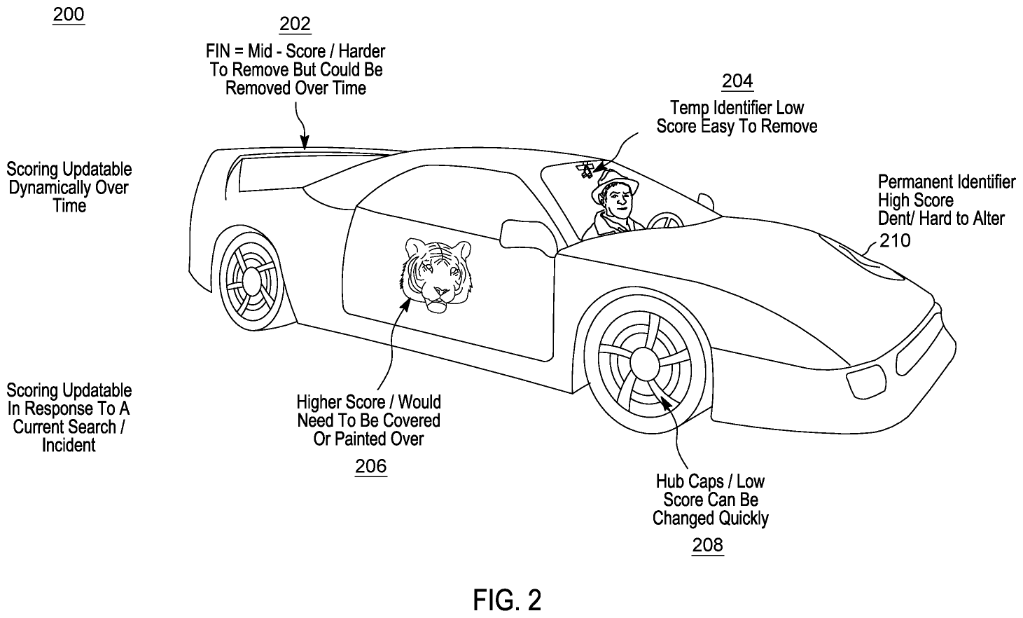

FIG. 2 is an illustration of an example display output of vehicular identifiers and associated scores generated by the vehicular profiling system of FIG. 1 in accordance with some embodiments. While the vehicle profile shows an individual seated in the vehicle, the vehicle may also be empty, depending on when the images collected by the various camera sources are taken.

The vehicular profile 200 may be transmitted by the vehicular profiling system for output to a display at either the primary device and/or one or more secondary device(s). As described previously, the primary device may be the device which enrolled the vehicle in the system, such as an owner of the vehicle, and/or transmitted for display in response to a query received by the system from either the primary device and/or a secondary device associated with an agency. As described previously, the query for the profile, may be based on the enrolled vehicle having been stolen, or may be based on other reasons from an interested party having access privileges to vehicles enrolled in the system, such as leasing companies and/or insurance companies seeking updates to conditions of the vehicle. For example, a request for the profile and request for an updated profile may receive at the profiling system from an insurance company, after a severe hurricane in a region where the car is known to be located, so as to determine potential water intrusion caused by flooding. The vehicle profile including the recoverability-likelihood score(s) may be uploaded to a secondary device associated with a law enforcement agency in response to a query from the secondary device indicating that the vehicle has been stolen. The vehicle profile including the recoverability-likelihood score may also be uploaded to a secondary device associated with a law enforcement agency in response to an instruction from the primary device indicating that the enrolled vehicle has been stolen.

The vehicular profile 200 is shown with a plurality of example identifiers, however it is to be appreciated that the profile is not limited to those example identifiers, a variety of one or more identifiers may be associated with each vehicle being profiled.

Identifier 202 labels a fin on the vehicle having a medium score. Tagged information pertaining to the fin may be included, such as “fin may be removed over time”. The medium score may generate as a result of a numerical value falling within a predetermined threshold associated with fin removal. The score for fin removal may further be impacted based on the make and model of the vehicle. A fin added as an after-market item may be easier to remove that a fin that forms a more integral part of the vehicle.

Identifier 204 labels an ornamental element hanging from the review mirror. Dependent on the type of ornamental element and attachment means to the mirrors, such and identifier may be categorized as temporary and scored with a low score. The low score may be generated as a result of a numerical value falling below a predetermined threshold associated with rear view mirror ornaments. Tagged information pertaining to the ornament may also be included, such as “fuzzy dice ornament easily removed”.

Identifier 206 labels an emblem (e.g. picture, symbol, stripe, and signage) on a door panel of the vehicle. The identifier may be categorized as a permanent identifier and scored with a high score if the emblem is painted on the door panel and not easily removed. The identifier may be categorized as a temporary identifier and scored with a low score if the symbol is adhered to the door handle in a more temporary manner, such as magnetically mounted to the door panel. The scoring may be generated as a result of a numerical value exceeding a predetermined threshold associated with emblem and the manner to which it is adhered to a vehicle. Tagged information pertaining to the signage may be included, such as for example, “painted emblem, difficult to remove”, “magnetic emblem, easy to remove”, and the like.

Identifier 208 labels hubcaps of the vehicle as having a low score, as these may be easily removed. The scoring may be generated as a result of a numerical value falling below a predetermined threshold associated with hubcaps and the manner to which it hubcaps are mounted to a vehicle. However, if the make and model of the vehicle includes hub caps which require a special tool for removal, then the score may be increased. Tagged information pertaining to the hubcaps may be included, such as for example, “generic hubcaps, easy to remove” based on a low score or “specialty hubcaps, difficult to remove” based on a high score.

Identifier 210 labels a dent located on the hood of the vehicle with a high score, and an indication that the dent is difficult to alter. The scoring may be generated as a result of a numerical value (or values) and/or one or more predetermined threshold(s) associated with dent parameters, for the particular make and model of vehicle. The one or more dent-related parameters used in scoring may include, but are not limited to, location of dent, size of dent, and information stored within the system pertaining to material associated with dent location for a particular make/model (e.g. fiberglass, aluminum, steel). Tagged information pertaining to the dent may be included, such as for example, “dent difficult to alter” based on a high score.

While shown on the display of FIG. 2, as low, medium, and high scores, the display may further include the numerical values and/or associated thresholds. Alternatively, the display may provide a user interface which allows for an identifier to be selected (mouse click or touch) which can result in a display of additional information pertaining to the identifier, For example, the numerical values and threshold, and statistics for the make and model of the vehicle may be further displayed.

Additionally, the various identifiers may be weighted to generate individual and/or an overall recoverability-likelihood score. The higher the number of unique and difficult to modify identifiers, the higher the recoverability-likelihood score. Such customized scoring may be dynamically updatable over time, prior to any stealing of a vehicle enrolled in the system. Weights may be adjusted based on the detectability of the temporary and permanent unique identifiers under predetermined vehicular operating conditions and/or contextual environments. For example, the overall recoverability score of a vehicle may be adjusted over time, as a result of difficult-to-remove/difficult to modify unique identifiers, such as a dent in a door, sun faded areas of the car, paint splatters or unusual wear and tear patters. The customized scoring of a vehicle enrolled in the system may be also be dynamically updated over time, post auto theft. For example, the overall recoverability score of a vehicle may decrease over time, as a result of easily modifiable or removable identifiers, after the enrolled vehicle has been stolen. The ability for law enforcement to identify permanent and temporary identifiers associated with a particular vehicle and to be provided with information as to which identifiers are unique and permanent to the vehicle, and which identifiers are more likely to have been removed or modified may greatly facilitate and improve recovery of a stolen vehicle.

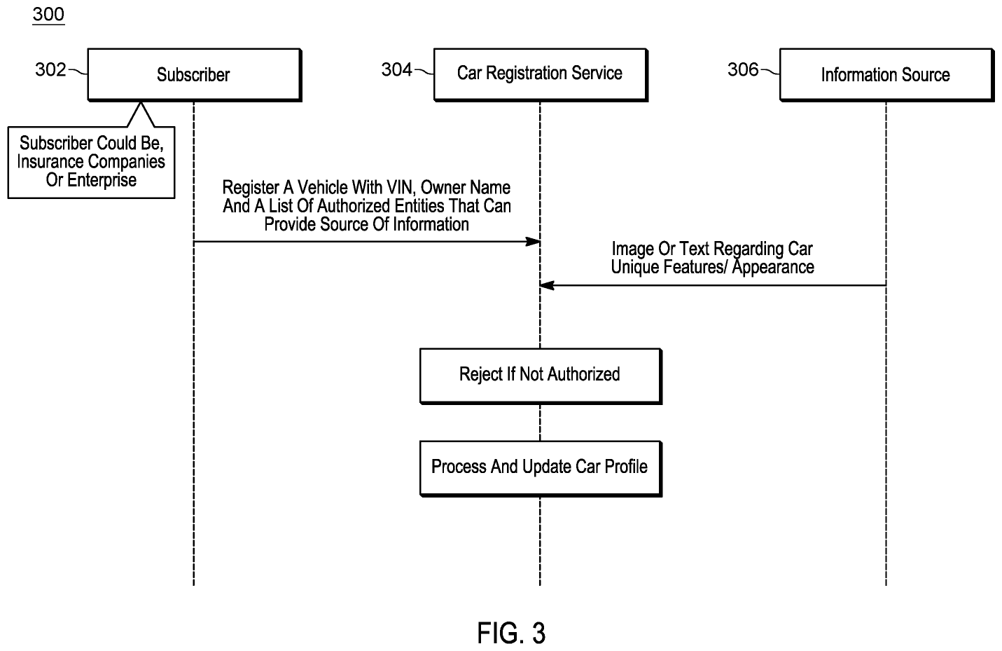

FIG. 3 is an example timeline for vehicular profiling in accordance with some embodiments. Timeline 300 begins at 302 with a potential subscriber requesting to enroll the vehicular profile system of FIG. 1. The subscriber may be an individual consumer, insurance and/or other enterprise having access to a computer, cell phone, tablet, display radio or the like. The potential subscriber registers a vehicle with information identifying themselves and the vehicle, for example, vehicle identification number (VIN), owner name.

The registration service 304 (associated with car registration service 110 of FIG. 1) further includes acquiring access to one or more video sources associated with the vehicle. The access to video sources may include, but is not limited to, video cameras outside (and possibly inside) the vehicle itself, home security cameras that are generally aimed at the vehicle when parked, and cell phone or tablet images uploaded by the owner subscriber. The home security cameras may be accessed by the profiling system on a periodic basis, or may be triggered by some contextual event, such as a hurricane, earthquake, flood, or other environmental trigger which may cause a threat to the condition of the vehicle. Inquiries may be automatically generated and transmitted from the registration service to the primary device to determine a context associated with a particular vehicular identifier.

The registration service 304 may further include selectable options for remote camera video access from which the user can select. Such remote camera sources may include but are not limited to toll cameras, street light cameras, and parking lot cameras, which are triggered based on tracked GPS location of the vehicle. Images taken by remote cameras advantageously provide for automated updates to the vehicular profile without user intervention. The user may opt to limit the video sources to one or more of their own vide source (such as cell phone pictures and/or home security cameras) if desired. Other selectable options for video sources may include, but are not limited to, car dealerships, automotive repair shops, or other locations having remote cameras which may also be enrolled in the system.

During initial enrollment the registration service 304 of vehicular profiling system of FIG. 1 determines if a sufficient number of video sources are available and that the potential subscriber has appropriate permissions for access to the vehicle and the image sources. For example, a potential subscriber attempting to use a neighbor's security camera system would be rejected. The registration will include processing live captured images of the vehicle to-be-enrolled and previously recorded images of a base version of the vehicle to determine whether there is sufficient access to image resources to build a profile. An authorized user or enterprise providing access to sufficient video cameras to build a profile will be accepted for enrollment in the system. As previously described, the profile includes a recoverability-likelihood score based on the characterized unique identifiers and provide the recoverability-likelihood score to a primary device associated with capturing the live captured images. Again, the device associated with capturing the images may, but need to be, the device that captures the actual images.

Information sources, including images and/or text updates pertaining to the vehicle can be uploaded to the registration service for processing at 306, via the processing database 108 of FIG. 1.

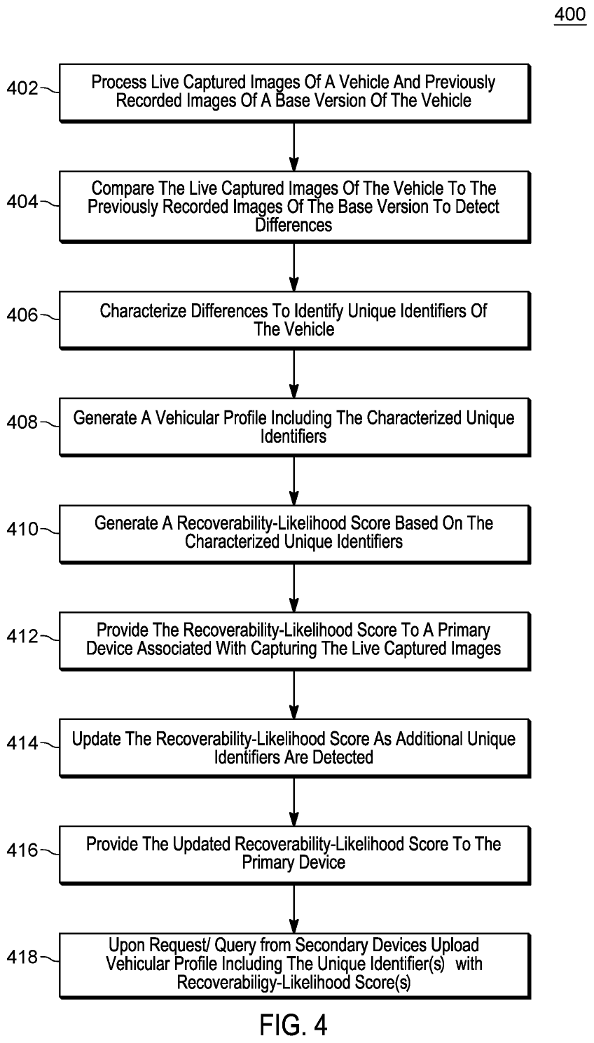

FIG. 4 is a flowchart of a method 400 for generating a vehicular profile in accordance with some embodiments. Method 400 begins at 402 by processing live captured images of a vehicle, such as vehicle 114 of FIG. 1, and previously recorded images of a base version of the vehicle. The base version may be images provided by car manufacturer for a particular make and model of a vehicle. The method continues at 404 by comparing the live captured images of the vehicle to the base version to detect differences therebetween. For example, the vehicle may have had additional features added to or removed from the vehicle at the time of enrollment. The differences are characterized to identify unique identifiers at 406. For example video processing and analytics in conjunction with machine learning may characterize certain identifiers as being unique to the vehicle, such as a dent, paint splatter on car body or tires, custom hubcaps, to name a few. The method continues at 410 with generating a recoverability-likelihood score based on the characterized unique identifiers. The recoverability-likelihood score may be communicated to a first/primary device associated with capturing the images. The recoverability score may be communicated as a numerical score and/or provided in terms of Low. Medium. High, and may include tagged information pertaining to the score, as was described in conjunction with FIG. 2. The recoverability-likelihood score may be communicated to a cell phone or computer of the vehicle owner subscriber. The recoverability-likelihood score may also be communicated to an agency, such as an insurance agency, leasing agency or other agency subscribed to the system having a vested interest in the vehicle.

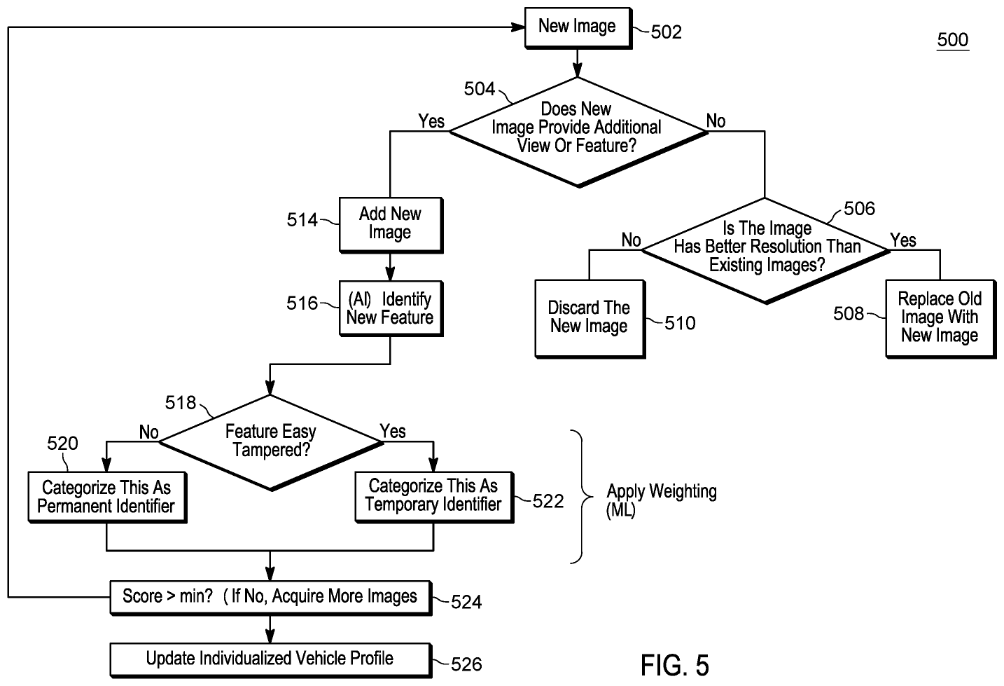

In some embodiments, the recoverability-likelihood score may be updated at 414 over time as unique additional identifiers are added ore removed over time. The detection of additional unique identifiers over time is further described in conjunction with FIG. 5. Updated recoverability-likelihood scores are communicated to the primary device associated with capturing the images and/or agencies enrolled in the system. The vehicular profile including the unique identifiers and recoverability score may be uploaded from the vehicular profile system to agencies upon request. For example, the vehicular profile including the unique identifiers and recoverability score may be uploaded to a law enforcement agency and/or law enforcement vehicle in response to a query based on the vehicle being stolen.

The basis for the car being stolen may also impact the recoverability-likelihood score and characterization of unique identifiers prior to release of the profile. For example, recoverability scores and individual identifier weighting may be different for a vehicle carjacked by a teenager as compared to a vehicle stolen by a family member.

FIG. 5 is a flowchart of a method 500 for updating a vehicular profile in accordance with some embodiments. The method begins at 502 with receiving a new image associated with a vehicle enrolled in a vehicular profiling system, such as the vehicular profiling system of FIG. 1. For example, the new images may be received from one or more of various video devices as previously described for processing by interactive video processor of the processing database 108. At 504, video processing and analytics determines whether the image provides an additional view or feature of an enrolled vehicle, such as vehicle 114 of FIG. 1. If the image is of an already existing identifier, then verification is made at 506 as to the resolution of the new image to an existing image of the identifier. If the resolution of the new image is better than the previous image, then the new image replaces the previously stored image at 508. If the resolution of the new image is lower than the previous image, then the image can be deleted at 510. Additionally, at 508, the method may further include (not shown) detecting changes between the old image of the previously identified unique identifier and the new image, and further updating of the vehicular profile and the recoverability-likelihood score based on the changes to the previously identified unique identifier.

If the new image provides an additional view or new feature at 504, then the new image is stored at 514 and the new feature is identified, using for example artificial intelligence (AI), at 516. A determination is made ay 518 as to the tamperability of the feature. For example AI in conjunction with machine learning of various pre-stored vehicular identifiers may be used to establish a tamperability index to which the new unique identifier may be characterized. An identifier that is not easily modified may be categorized (or characterized) as a permanent identifier at 520, and an identifier that is easily modified may be categorized (or characterized) as a temporary identifier at 522. Each identifier (permanent and/or temporary) may be further weighted and individually scored and a further overall score may also be calculated based on the weighted scores. As previously described for example, the recoverability-likelihood score may be based on applying relatively lower weights to the temporary unique identifiers and relatively higher weights applied to the permanent unique identifiers.

The updated vehicle profile information including the characterized unique identifiers along with individual scores and/overall score and any tagged information pertaining to the feature are stored within a memory of the vehicular profiling system. An additional (optional) scoring verification may be made at 524 to determine if additional images of an identified feature may be recommended, such as for improved resolution or alternate image views of the feature, which would return the method to 502. The vehicle profile including the characterized unique identifiers may be further communicated to one or more communication devices in response to a query and/or automatically uploaded to external devices at 526. As was previously described, such device(s) may include a primary device associated a consumer who enrolled the vehicle, and/or one or more secondary device(s) associated with agencies having a vested interest in the vehicle, such as devices associated with a law enforcement agency responding to a stolen vehicle notification, and/or devices associated with insurance and/or leasing agencies for monitoring vehicular conditions, to name a few. In some cases, it is also feasible that the primary device may be the agency device.

Accordingly, the embodiments have provided for a system and method for generating an improved vehicular profile. The profile, including the identification of unique identifiers and recoverability-likelihood score is beneficial to consumers and various agencies, including but not limited to, insurance agencies, leasing companies, and law enforcement.

As should be appreciated from the detailed description above, the operations and functions of the vehicular profiling system are sufficiently complex as to require their implementation on a computer system, and cannot be performed, as a practical matter, in the human mind. The devices such as set forth herein are understood as requiring and providing speed and accuracy and complexity management that are not obtainable by human mental steps, in addition to the inherently digital nature of such operations (e.g., a human mind cannot interface directly with data storage, cannot transmit or receive electronic messages, electronically encoded audio, etc., and cannot extract audio and text features from the call inputs in real time or calculate and store a recoverability-likelihood score associated with the vehicle, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A vehicular profiling system, comprising;
a processor configured to:
receive a request, from a primary communication device, for a vehicle to be enrolled in the vehicular profiling system;
process live captured images of the vehicle to-be-enrolled and previously recorded images of a base version of the vehicle;
compare the live captured images of the vehicle to-be-enrolled to the previously recorded images of the base version of the vehicle to detect differences between them;
characterize the differences to identify unique identifiers of the vehicle to-be-enrolled;
generate a vehicular profile including the characterized unique identifiers;
generate a recoverability-likelihood score based on the characterized unique identifiers and provide the recoverability-likelihood score to a primary device;
enroll the vehicle in the vehicular profiling system; and
upload the vehicular profile including the unique identifiers to the primary communication device in response to a query.

2. The vehicular profiling system of claim 1, wherein the processor is further configured to:
upload the vehicular profile including the unique identifiers and the recoverability-likelihood score to a secondary device in response to a query from the secondary device, the secondary device comprising one or more of: a law enforcement agency device, leasing company device, insurance company device.

3. The vehicular profiling system of claim 1, wherein the processor is further configured to:
upload the vehicular profile including the unique identifiers and the recoverability-likelihood score to a secondary device associated with a law enforcement agency in response to an instruction from the primary indicating that the enrolled vehicle has been stolen.

4. The vehicular profiling system of claim 1, further comprising:
image capturing sources for capturing additional live images of the enrolled vehicle over time, and
the processor being further configured to identify new unique identifiers from the additional live captured images and to update the recoverability-likelihood score based thereon.

5. The vehicular profiling system of claim 1, wherein the processor is further configured to:
further characterize the unique identifiers to separately identify temporary unique identifiers and permanent unique identifiers of the vehicle; and
generate the recoverability-likelihood score based on relatively lower weights applied to the temporary unique identifiers and relatively higher weights applied to the permanent unique identifiers.

6. The vehicular profiling system of claim 5, wherein the processor is further configured to:
further weight the temporary and permanent unique identifiers based on detectability of the temporary and permanent unique identifiers under predetermined vehicular operating conditions and contextual environments; and
update the recoverability-likelihood score based on the further weight associated with the vehicular operating conditions and contextual environments

7. The vehicular profiling system of claim 1, wherein the vehicular profiling system operates as part of a subscription service.

8. The vehicular profiling system of claim 1, wherein the processor is further configured to:
generate a visual representation of the vehicular profile including at least one unique vehicular identifier and at least one recoverability-likelihood score for display at a secondary device.

9. The vehicular profiling system of claim of claim 1, wherein the processor is further configured to generate and transmit inquiries to the primary device to determine a context associated with the unique identifiers.

10. The vehicular profiling system of claim of claim 9, wherein the recoverability-likelihood score is updated based on responses to the inquiries.

11. The vehicular profiling system of claim 1, further comprising:
one or more remote cameras operatively coupled to the vehicular profiling system for detecting the enrolled vehicle and capturing live images of the vehicle for input to and processing by the vehicular profiling system.

12. The vehicular profiling system of claim 11, wherein the one or more remote cameras comprise:
a camera on a law enforcement vehicle;
a remote surveillance camera;
a toll camera; and
a home security camera.

13. The vehicular profiling system of claim 1, upon receipt of a stolen vehicle notification associated with the enrolled vehicle, the vehicular profile including the unique identifiers and recoverability-likelihood score are uploaded to a law enforcement vehicle computer for display at a law enforcement vehicle.

14. The vehicular profiling system of claim 13, wherein the law enforcement vehicle includes a camera operatively coupled to the law enforcement vehicle computer, and images captured by the camera of a potentially stolen vehicle are automatically uploaded to the vehicular profiling system for match verification.

15. The vehicular profiling system of claim 1, wherein upon receipt of a stolen vehicle notification associated with the enrolled vehicle, the vehicular profile including the unique identifiers and recoverability-likelihood are further automatically uploaded to remote surveillance camera systems and toll camera systems associated with the vehicular profiling system; and
images captured by one or more of the surveillance camera systems and toll camera systems potentially matching the stolen vehicle are automatically uploaded to the vehicular profiling system for match verification.

16. A method for generating a vehicular profile, comprising:
receiving a request, at a processing device, for a vehicle to be enrolled in a vehicular profiling system;
processing live captured images of the vehicle to-be-enrolled and previously recorded images of a base version of the vehicle;
comparing the live captured images of the vehicle to-be-enrolled to the previously recorded images of the base version of the vehicle to detect differences between them;
characterizing the differences to identify unique identifiers of the vehicle to-be-enrolled;
generating a vehicular profile including the characterized unique identifiers;
calculating a recoverability-likelihood score based on the characterized unique identifiers;
storing the vehicular profile including the characterized unique identifiers and recoverability-likelihood score in a memory of the vehicular profiling system; and
communicating the vehicular profile including the unique identifiers to a communication device in response to a query.

17. The method of 16, wherein communicating the vehicular profile including the unique identifiers further includes communicating the recoverability-likelihood score.

18. The method of 16, further comprising:
characterizing the unique identifiers to separately identify temporary and permanent unique identifiers of the vehicle;
generating the recoverability-likelihood score based on relatively lower weights applied to the temporary unique identifiers and relatively higher weights applied to the permanent unique identifiers.

19. The method of 16, further comprising:
receiving additional live captured images, over time, from one or more image capturing sources associated with the vehicular profiling system;
detecting new unique identifiers associated with the vehicle; and
updating the vehicular profile and the recoverability-likelihood score based on the new unique identifiers.

20. The method of 16, further comprising:
receiving additional live captured images, over time, from one or more image capturing sources associated with the vehicular profiling system;
detecting changes in previously identified unique identifiers; and
updating the vehicular profile and the recoverability-likelihood score based on the detected changes to the previously identified unique identifiers.
